(19) United States
(12) Patent Application Publication
(10) Pub. No.: US 2012/0295092 A1
(43) Pub. Date: Nov. 22, 2012

(54) SHAPED CUSHIONING ELEMENT

(76) Inventor: Julian Botsch, Fischbachau (DE)

(21) Appl. No.: 13/576,259

(22) PCT Filed: Feb. 4, 2011
(86) PCT No.: PCT/EP2011/000522

§ 371 Date: Jul. 31, 2012

(30) Foreign Application Priority Data
Feb. 5, 2010 (DE) 10 2010 007 145.5

(51) Int. Cl. B32B 1/00; B32B 5/02

(52) U.S. Cl. 428/221

(57) ABSTRACT

A shaped cushioning element (10) includes elastically compliant shaped bodies lying in a covering (11). The shaped bodies form a shaped body filling that fills the covering in a shape-retaining manner. The covering has a textile structure (25) including a deformation-resisting device such that the elastic compliance of the shaped cushioning element is designed to be lower in a first axial direction than the elastic compliance in a second axial direction.

### CROSS REFERENCE TO RELATED APPLICATIONS

This application is a United States National Phase Application of International Application PCT/EP2011/000522 and claims the benefit of priority under 35 U.S.C. §119 of German Patent Application DE 10 2010 007 145.5 filed Feb. 5, 2010, the entire contents of which are incorporated herein by reference.

### FIELD OF THE INVENTION

The present invention relates to a shaped cushioning element comprising elastically compliant shaped bodies lying in a covering, said shaped bodies forming a shaped body filling that fills the covering in a shape-retaining manner.

### BACKGROUND OF THE INVENTION

Shaped cushioning elements of the afore-cited type are employed for instance in support frames of backpacks and are supposed to enhance wearing comfort due to their arrangement between carrying straps and body contact zones. In this context, it has already been realized that the compliance of the shaped cushioning elements should be adapted to the magnitude of the acting forces in order to still enable a defined force transmission to the body contact zones in spite of the cushioning. For this purpose, it is necessary that the shaped cushioning elements exhibit a defined shape and a corresponding deformation resistance also when being subjected to stress in order to sufficiently control the type of force transmission to the body contact zone. In this regard, the known shaped cushioning elements only provide an unsatisfactory solution, since good force transmission properties regularly adversely affect the attainable wearing comfort.

### SUMMARY OF THE INVENTION

It is an object of the present invention to improve the shaped cushioning elements to the effect that they enable a high degree of cushioning comfort without significantly impairing the shape-retaining properties as well as the force transmission properties.

To attain this object the inventive shaped cushioning element comprises elastically compliant shaped bodies lying in a covering. The shaped bodies form a shaped body filling that fills the covering in a shape-retaining manner. The covering has a textile structure comprising a deformation-resisting device such that the elastic compliance of the shaped cushioning element is designed to be lower in a first axial direction than the elastic compliance in a second axial direction.

The term “textile structure” shall not be construed in terms of a limitation regarding the actual material properties of the fibers forming the structure, but instead shall merely exemplarily refer to a structure featuring preferred axial directions which are defined by fiber directions or else by molecular orientations of the material, thereby exhibiting different elastic compliances. For instance, this means that a tensional force acting in a first axial direction in the structure causes a different deformation or elongation of the structure compared to a tensional force or tensional stress acting in another axial direction in the structure.

The inventive shaped cushioning element can be realized in a large variety of embodiments. In particular applications are possible, where the cushioning element is provided for instance for the interposed arrangement between support straps and body contact zones. In this context, in addition to an elastic damping by means of adaptation to the body contact zone while at the same time exhibiting a largely shape-retaining effect, the shaped cushioning element enables a uniform load distribution. Likewise, applications are conceivable, where the shaped cushioning element being designed in the form of a protection element is provided with or else without an external impact protection shell. For this purpose, a possible application is the arrangement of corresponding shaped cushioning elements in a protective helmet, wherein in particular in this case, the shaped cushioning elements can also be provided with an additional external shell (helmet shell). It is also conceivable to use the shaped cushioning elements as body protection elements, wherein in this case, the shaped cushioning elements can be designed for instance as back protectors. Another example with respect to the use of the shaped cushioning elements, in particular if a uniform load distribution is to be realized, preferably with simultaneous aeration of the stressed surfaces, is the utilization of a correspondingly designed shaped cushioning element as a saddle pad, wherein in this case, the padding of a riding saddle having a shaped cushioning for adaptation to the back of the horse is equally possible just like the padding of a bicycle saddle, wherein a correspondingly designed shaped cushioning element can be employed for instance in the manner of so-called “gel pads”.

It is particularly advantageous if the textile structure for realizing the different elastic compliances features first fibers extending in a first axial direction and second fibers extending in a second axial direction, wherein the first fibers in the fiber direction feature a smaller elastic compliance than the second fibers, so that the selected fibers and/or the quantity of the fibers in the respective axial direction serve for defining the properties of the structure and the covering, respectively.

For instance, the deformation-resisting device can be formed by a fiber core or a fiber covering inhibiting deformation of the first fibers in an axial direction.

At least the first fibers of the textile structure can feature a thermoplastic material matrix.

The deformation-resisting device can be formed in particular by a thermoplastic fixation of the first fibers of the textile structure.

In order to further enhance wearing comfort it is advantageous to design the covering so as to be breathable at least in some parts thereof.

For this purpose, the structure of the covering can be designed in a reticular fashion at least in some parts thereof.

In contrast hereto, in a particular embodiment, the formation of different elastic compliances in different axial directions can be realized by the aspect that the difference in the elastic compliances is not attained by the structure itself being correspondingly designed, but by a deformation-resisting device being designed for inhibiting or else limiting deformation of the structure or the covering in an axial direction, which device can be integrated in the structure of the covering or can also be designed independently of the structure or the covering and is in contact with the covering solely from the exterior or the interior.

It is particularly advantageous if the deformation-resisting device is formed by a support device acting on the textile structure from the exterior or the interior.

In this regard, the deformation-resisting device can be formed by a thermoplastic fixation of a partial surface of the covering.

Moreover, it is advantageous if the covering is formed of a thermoplastic material at least in some parts thereof.

Hence, for instance the deformation-resisting device can also be formed by a support device acting on the covering from the exterior or the interior, wherein the support device preferably acts such that a relative movement of the covering with respect to the support device is prevented in the regions of the covering lying adjacent to the support device.

In particular, it is also possible to design the deformation-resisting device by a fixation of a partial surface of the covering being preferably produced in a thermoplastic manner. In particular in the case, where the covering is at least partially formed of a thermoplastic material, such a fixation can be produced in a thermoplastic manner, for instance by deformation of the covering in particular by a deep-drawing process by simultaneously exposing the covering to temperature, so that in particular in the regions being exposed to increased temperature stress, the elastic compliances are limited by the aspect that a permanent thermoplastic deformation occurs in said regions.

It proves to be particularly advantageous, in particular with respect to enhanced wearing comfort, if the structure of the covering is designed so as to be breathable at least in some parts thereof in order to enable aeration of the body contact zones in said regions which can be defined for instance by body contact zones.

Hereinafter, preferred embodiments of the invention will be described in greater detail with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a first exemplary embodiment of a shaped cushioning element;

FIG. 2 is a schematic view of the effect of another possible embodiment of a shaped cushioning element.

### DESCRIPTION OF THE PREFERRED EMBODIMENTS

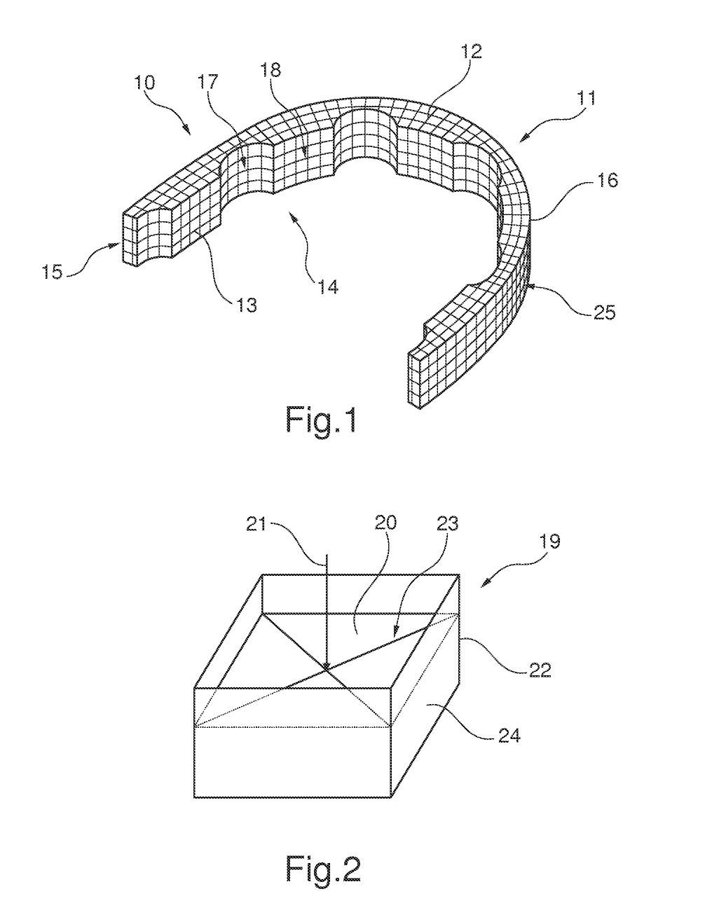

Referring to the drawings in particular, FIG. 1 as a possible exemplary embodiment shows a shaped cushioning element 10 which can be employed for instance for partially lining a protective helmet. The shaped cushioning element 10 in the present case features a covering 11 being formed of a textile, reticular structure 25 having first fibers 12 and second fibers 13 extending in two main axial directions. The fibers 12, which in the present case extend transversely to the longitudinal direction of the shaped cushioning element 10, in the fiber direction feature a smaller elastic compliance compared to the fibers 13 extending in the longitudinal direction of the shaped cushioning element 10. In the present case, the covering 11 features a textile structure 25 being formed of the fibers 12 and 13 defining the entire external surface of the covering 11. By the same token, it is possible that the covering 11 is limited to the front contact side 14 of the shaped cushioning element 10 being essentially visible in FIG. 1, and a rear connection side 15, which can be provided for instance for connection with a helmet shell (not shown here in greater detail), can be made of a different material, in particular a foil material, with which the structure 25 of the covering 11 for instance can be welded. For this purpose, it is advantageous if the covering 11 or the fibers 12, 13 feature a coating of a thermoplastically deformable material, for instance polyurethane, in order to enable the production of a welded connection.

In the exemplary embodiment shown in FIG. 1 provision is made for a shell mold 16 having a bracket-shaped design for defining a basic shape of the shaped cushioning element 10, here in the form of a semicircular ring, which mold can be disposed in the covering 11 itself for connection with the covering 11. The covering 11 is filled with elastically compliant shaped bodies which can be designed for instance as polystyrene balls, wherein the filling quantity of the covering 11 is selected such that a shape-retaining filling of the covering 11 is realized, which completely fills the covering without attaining pre-tensioning of the shaped body filling by means of overfilling, which would limit the relative movability of the individual shaped bodies of the shaped body filling relative to each other even in the absence of external forces acting on the covering 11.

As can be seen from FIG. 1, in the contact zone 14 the covering 11 features a topography being alternately composed of recessed background zones 17 and raised contact zones 18. This topography is enabled by the aspect that the covering 11 is thermoplastically deformed in a deep-drawing process while being exposed to temperature such that the background zones 17 and the contact zones 18 are formed alternately. Then, the covering 11 can be filled with the elastically compliant shaped bodies such that the topography illustrated in FIG. 1 is caused to be shape-retaining due to the supporting effect of the shaped bodies.

FIG. 2 once again shows the basic effect of a shaped cushioning element 19, which in the present case is composed of a covering 20 being filled in a shape-retaining manner with shaped bodies which, in their capacity as an externally disposed deformation-resisting device, are equipped with a support device 22 having a box-shaped design. Due to the external stress 21 being highlighted by the force arrow and due to the frame device or support device 22 acting as a deformation-resisting device, a deformation occurs only in the region of an upper surface 23 of the covering 20 illustrated in FIG. 2.

Instead of the support device 22 illustrated in FIG. 2, which has a box-shaped design, it would equally be possible to provide the covering 20 at the lateral faces 24 thereof with a surface topography of a partial surface being comparable to the support device 22 which features a corresponding deformation resistance. For this purpose, the covering 20 can be provided with a thermoplastically fixed coating in the region of the lateral faces 24.

While specific embodiments of the invention have been shown and described in detail to illustrate the application of the principles of the invention, it will be understood that the invention may be embodied otherwise without departing from such principles.

1. A shaped cushioning element comprising:
elastically compliant shaped bodies;
a covering, said shaped bodies lying in said covering, said shaped bodies forming a shaped body filling that fills the covering in a shape-retaining manner, wherein the covering has a textile structure comprising a deformation-resisting device such that the elastic compliance of the shaped cushioning element is designed to be lower in a first axial direction than the elastic compliance in a second axial direction.

2. A shaped cushioning element according to claim 1, wherein the textile structure comprises first fibers for realizing the different elastic compliances, said first fibers extending in a first axial direction, and second fibers extending in a second axial direction, wherein the first fibers in the first axial direction exhibit a smaller elastic compliance than the second fibers.

3. A shaped cushioning element according to claim 2, wherein the deformation-resisting device is formed by a fiber core or a fiber covering, inhibiting deformation of the first fibers in one axial direction.

4. A shaped cushioning element according to claim 2, wherein at least the first fibers of the textile structure comprises a thermoplastic material matrix.

5. A shaped cushioning element according to claim 2, wherein the deformation-resisting device is formed by a thermoplastic fixation of the first fibers of the textile structure.

6. A shaped cushioning element according to claim 1, wherein the covering is formed so as to be breathable at least in some parts thereof.

7. A shaped cushioning element according to claim 1, wherein the structure of the covering is designed in a reticular fashion at least in some parts thereof.

8. A shaped cushioning element according to claim 1, wherein the deformation-resisting device is formed by a support device acting on the textile structure from the exterior or the interior.

9. A shaped cushioning element according to claim 8, wherein the deformation-resisting device is formed by a thermoplastic fixation of a partial surface of the covering.

10. A shaped cushioning element according to claim 8, wherein the covering is made of a thermoplastic material at least in some parts thereof.

11. A shaped cushioning element comprising:
elastically compliant shaped bodies;
a cover, said shaped bodies forming a shaped body filling that fills said cover in a shape-retaining manner, said cover comprising a deformation-resisting device with an elastic compliance that is lower in a first axial direction than an elastic compliance in a second axial direction.

12. A shaped cushioning element according to claim 11, wherein:
said cover comprises first fibers with a first elastic compliance, said first fibers extending in a first axial direction; and
second fibers with a second elastic compliance, said second fibers extending in a second axial direction;
said first elastic compliance is smaller than said second elastic compliance.

13. A shaped cushioning element according to claim 12, wherein said deformation-resisting device is formed by a fiber core or a fiber cover, inhibiting deformation of said first fibers in one axial direction.

14. A shaped cushioning element according to claim 12, wherein said first fibers comprises a thermoplastic material matrix.

15. A shaped cushioning element according to claim 12, wherein said deformation-resisting device comprises a thermoplastic fixation of said first fibers.

16. A shaped cushioning element according to claim 11, wherein said cover is gas permeable at least in some parts thereof.

17. A shaped cushioning element according to claim 11, wherein said cover comprises a structure including one or more reticular portions.

18. A shaped cushioning element according to claim 11, wherein said deformation-resisting device is formed by a support device acting on a remainder of said cover from an exterior or an interior thereof.

19. A shaped cushioning element according to claim 18, wherein said deformation-resisting device is formed by a thermoplastic fixation of a partial surface of said cover.

20. A shaped cushioning element according to claim 18, wherein said cover comprises a thermoplastic material at least in some portions thereof.
